(19) United States
(12) Patent Application Publication
(10) Pub. No.: US 2006/0230794 A1
(43) Pub. Date: Oct. 19, 2006

(54) Locking device for vehicular tool cabinet

(76) Inventor: George Liu, Douliou City (TW)

Correspondence Address: BIRCH STEWART KOLASCH & BIRCH, PO BOX 747, FALLS CHURCH, VA, 22040-0747, US

(21) Appl. No.: 11/106,608

(22) Filed: Apr. 15, 2005

(51) Int. Cl. E05B 65/48

(52) U.S. Cl. 70/63; 70/159

(57) ABSTRACT

A locking device for vehicular tool cabinet uses to fasten a housing body and a covering body, such locking device comprises a locking and unlocking section and a number lock; the locking and unlocking section is mounted on the housing body and includes a clasping portion which motion is restricted by the number lock; the covering body comprises a receiving portion located corresponding to the clasping portion; and the housing body and the covering body can be buckled together by the clasping portion and the receiving portion. After the number lock has been unlocked, the locking and unlocking section can be operated to separate the clasping portion and the receiving portion, so as to unlock the vehicular tool cabinet.

### FIELD OF THE INVENTION

The present invention relates to a vehicular tool cabinet and more particularly, to a locking device for vehicular tool cabinet.

### BACKGROUND OF THE INVENTION

A vehicular tool cabinet is referred to a kit that is placed at the trunk of a car or at the cargo carrier of a truck for keeping different kinds of tools such as spanner, jack, spare tire, warning triangle and tow ropes, etc. which are needed during the repair of vehicle.

General vehicular tool cabinets simply use a clip and buckle spring structure for closure, such structure will easily be released due to the over vibration of the vehicle during traveling, thus causing the vehicular tool cabinet to bounce open during traveling and eventually leading to a possibility that the tools inside the vehicular tool cabinet might fall on the road and affect the driving safety.

### SUMMARY OF THE INVENTION

It is a primary object of the present invention to provide a locking device for vehicular tool cabinet, so as to allow the user to control the locking and unlocking section for separating the clasping portion and the receiving portion after unlocking the number lock, thus can unlock the vehicular tool cabinet.

The present invention refers to a locking device for vehicular tool cabinet uses to fasten a housing body and a covering body. Such locking device comprises a locking and unlocking section and a number lock. The locking and unlocking section includes a clasping portion and a driving portion, such clasping portion is pivoted at the housing body and the clasping portion is fixedly attached to the driving portion. By controlling the motion of the driving portion, it can drive the clasping portion to rotate. The number lock comprises a tongue piece. The number lock is equipped on the housing body. The number lock includes a locking state and an unlocking state. When the number lock is at its locking state, the tongue piece will collide with the driving portion so as to restrict the motion of the driving portion. And the covering body has a receiving portion located corresponding to the clasping portion. The housing body and the covering body can be buckled together by the clasping portion and the receiving portion. When the number lock is still at its unlock state, the user can control the motion of the driving portion in order to drive and to rotate the clasping portion, causing the clasping portion and the receiving portion to separate.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the vehicular tool cabinet of the present invention.

FIG. 2 is a perspective view of the vehicular tool cabinet of the present invention under an unlocked state.

FIG. 3 is a structural view of the pulling plate after being disassembled.

FIG. 4A is another structural view of the locking device of the present invention.

FIG. 4B is an operating view of the locking device of the present invention.

FIG. 4C is another operating view of the locking device of the present invention.

### DESCRIPTION OF THE PREFERRED EMBODIMENTS

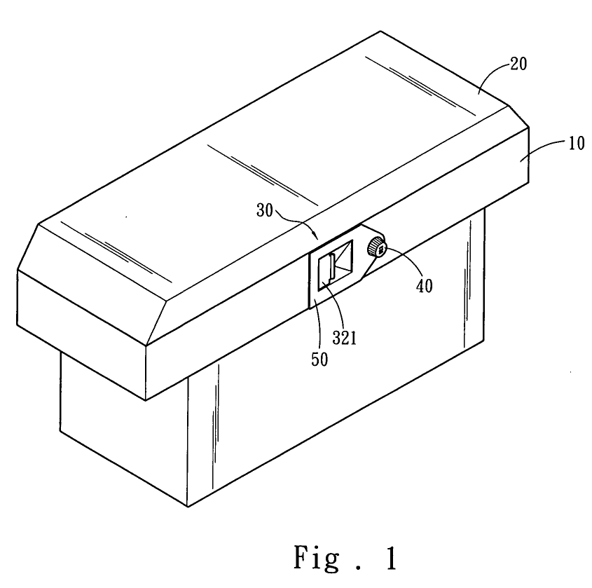

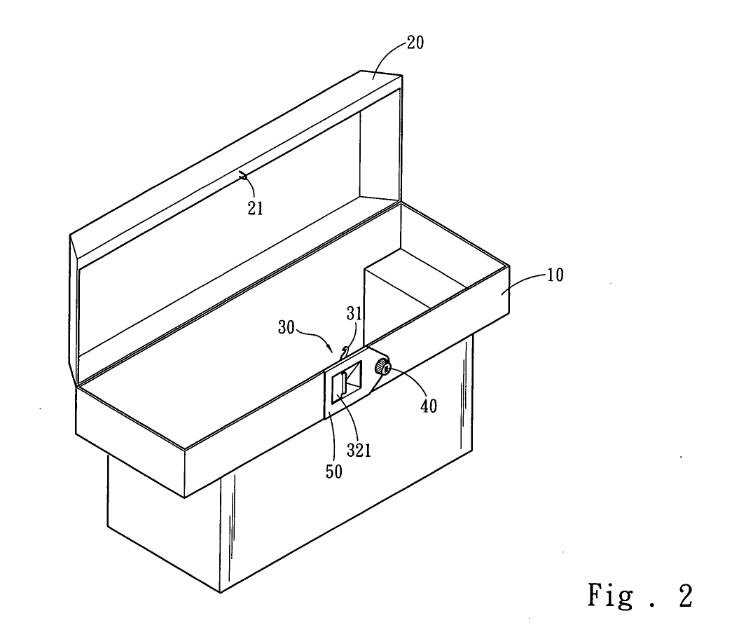

Please refer to FIGS. 1, 2, 3 and 4A. The present invention refers to a locking device for vehicular tool cabinet uses to fasten a housing body 10 and a covering body 20. Such locking device comprises a locking and unlocking section 30 and a number lock 40. The locking and unlocking section 30 includes a clasping portion 31 and a driving portion 32, such clasping portion 31 is pivoted at the housing body 10 and the clasping portion 31 is fixedly attached to the driving portion 32.

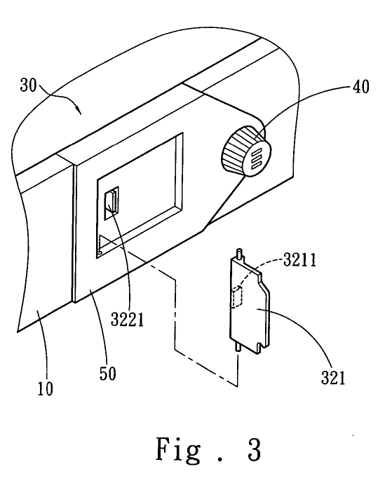

The driving portion 32 further comprises a pulling plate 321, a sliding part 322, a driving rod 323 and a resilient member 324. The pulling plate 321 and the sliding part 322 are located respectively at the two sides of the housing body 10. And the pulling plate 321 is pivoted to the housing body 10. The sliding part 322 is equipped on the housing body 10 by a sliding groove 33. The sliding part 322 includes a bulge 3221. The bulge 3221 passes through the housing body 10 and exposes at the other side of the housing body 10 (as shown in FIG. 3), and the pulling plate 321 has a pushing part 3211 located corresponding to the bulge 3221. The clasping portion 31 is fixedly attached at the driving rod 323 of the driving portion 32. Such driving rod 323 has a shielding part 3231, and the shielding part 3231 will collide with the sliding part 322. The two ends of the resilient member 324 are fixedly positioned between the driving rod 323 and the housing body 10 respectively. The resilient member 324 here can be any components having elasticity such as springs.

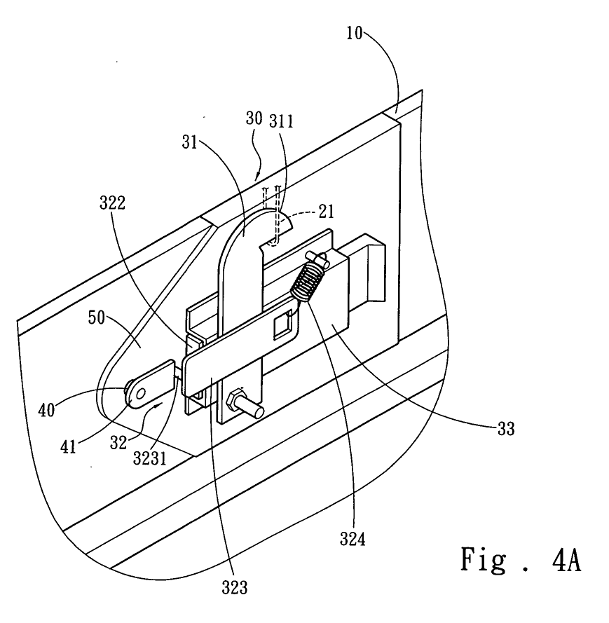

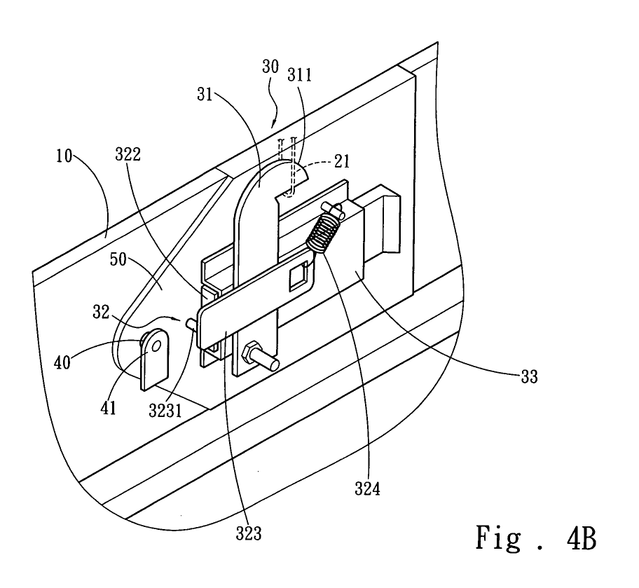

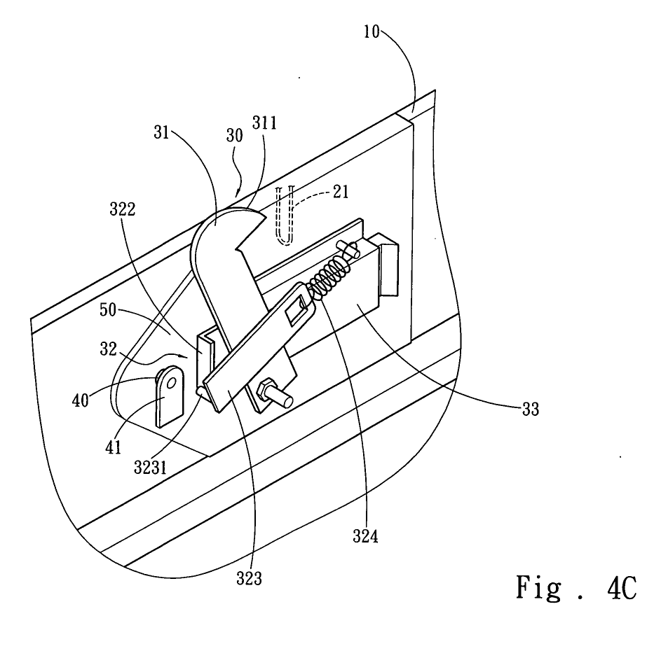

The number lock 40 comprises a tongue piece 41. The number lock 40 is equipped on the housing body 10. The number lock 40 includes a locking state and an unlocking state. When the number lock 40 is at its locking state, the tongue piece 41 will collide with the driving portion 32 so as to restrict the motion of the driving portion 32 (as shown in FIG. 4A). And the covering body 20 has a receiving portion 21 located corresponding to the clasping portion 31. The housing body 10 and the covering body 20 can be buckled together by the clasping portion 31 and the receiving portion 21.

Please refer to FIGS. 4B and 4C again. After the user has input a correct password, the number locked can be rotated to allow it to perform an unlocking state (as shown in FIG. 4B.). Then, the user can control the driving portion 32 to let the pulling plate 321 rotate and allow the pushing part 3221 to press against the bulge 3221, so that the sliding part 322 can slide within the sliding groove 33 and then pushes against the shielding part 3231. Thus, the clasping portion 31 can rotate and separate from the receiving portion 21 (as shown in FIG. 4C). The vehicular tool cabinet is then opened according to the above procedures.

When locking the vehicular tool cabinet, the clasping portion 31 can be restored to its original position by the resilient force of the resilient member 324 and then buckles together with the receiving portion 21. Then, rotate the number lock 40 to allow the tongue piece 41 to collide with the driving portion 32 so as to restrict the motion of the driving portion 32, causing the number lock 40 to return to a locked state and also lock the vehicular tool cabinet.

Furthermore, the clasping portion 31 can be an L-shape hooked body and the receiving portion 21 can be a corresponding hooked ring. The top end of the clasping portion 31 has a guiding arced angle 311. According to the above structure, when the covering body 20 covers the housing body 10, the receiving portion 21 of the covering body 20 will contact with the guiding arced angle 311 and then use the guiding arced angle 311 to push the clasping portion 31, causing the clasping portion 31 to rotate until the clasping portion 31 and the receiving portion 21 are buckled together.

For the convenience in assembling, the housing body 10 of the present invention can further equip with an embedding board 50. The embedding board 50 is mounted on the housing body 10 by a mosaic method. The locking and unlocking section 30 and the number lock 40 are both mounted on the embedding board 50, this can make the group operation of the locking and unlocking section 30 and the number lock 40 more convenient, thus can reduce the operating time.

According to the above stated, the present invention can provide a lockable vehicular tool cabinet to prevent the tools inside the vehicular tool cabinet to be stolen, and allow the user to lock and unlock the vehicular tool cabinet without using a key, thus accords with the demand of the user practically.

What is claimed is:

1. A locking device for vehicular tool cabinet uses to fasten a housing body and a covering body, comprising:
a locking and unlocking section having a clasping portion and a driving portion, the clasping portion is pivoted at the housing body and the clasping portion is fixedly attached to the driving portion, by controlling the driving portion, it can drive the clasping portion to rotate;
a number lock having a tongue piece, the number lock is equipped on the housing body, the number lock includes a locking state and an unlocking state, when the number lock is at its locking state, the tongue piece will collide with the driving portion so as to restrict the motion of the driving portion; and
the covering body having a receiving portion located corresponding to the clasping portion, the housing body and the covering body can be buckled together by the clasping portion and the receiving portion, when the number lock is at its unlock state, by controlling the motion of the driving portion, the clasping portion can be driven to rotate, causing the clasping portion and the receiving portion to separate.

2. The locking device for vehicular tool cabinet according to claim 1, wherein the driving portion further comprises a pulling plate, a sliding part, a driving rod and a resilient member; the pulling plate and the sliding part are located respectively at the two sides of the housing body; the pulling plate is pivoted to the housing body; the sliding part is equipped on the housing body by a sliding groove; the sliding part includes a bulge; the bulge passes through the housing body and exposes at the other side of the housing body; the pulling plate has a pushing part located corresponding to the bulge; the clasping portion is fixedly attached at the driving rod of the driving portion; the driving rod has a shielding part; the shielding part will collide with the sliding part; and the two ends of the resilient member are fixedly positioned between the driving rod and the housing body respectively, when the pulling plate rotates and allows the pushing part to press against the bulge, so that the sliding part can slide within the sliding groove and then pushes against the shielding part, thus, causing the clasping portion to rotate and to separate from the receiving portion, the clasping portion can again buckle with the receiving portion by the resilient member.

3. The locking device for vehicular tool cabinet according to claim 2, wherein the clasping portion can be an L-shape hooked body, the receiving portion can be a corresponding hooked ring, and the top end of the clasping portion has a guiding arced angle.

4. The locking device for vehicular tool cabinet according to claim 2, wherein the resilient member is a spring.

5. The locking device for vehicular tool cabinet according to claim 1, wherein the housing body further equips with an embedding board, the locking and unlocking section and the number lock are both mounted on the embedding board.
